(19) United States
(12) Patent Application Publication
(10) Pub. No.: US 2024/0086716 A1
(43) Pub. Date: Mar. 14, 2024

(54) METHOD AND APPARATUS FOR DEEP NEURAL NETWORKS HAVING ABILITY FOR ADVERSARIAL DETECTION

(71) Applicants: Robert Bosch GmbH, Stuttgart (DE); TSINGHUA UNIVERSITY, Beijing (CN)

(72) Inventors: Hang Su, Beijing (CN); Jun Zhu, Beijing (CN); Zhijie Deng, Beijing (CN); Ze Cheng, Shanghai (CN)

(21) Appl. No.: 18/263,576

(22) PCT Filed: Feb. 26, 2021
(86) PCT No.: PCT/CN2021/078103

§ 371 Date: Jul. 31, 2023

(51) Int. Cl. G06N 3/094

(52) U.S. Cl. CPC G06N 3/094

(57) ABSTRACT

A method for training a deep neural network (DNN) capable of adversarial detection. The DNN is configured with a plurality of sets of weights candidates. The method includes inputting training data selected from training data set to the DNN. The method further includes calculating, based on the training data, a first term for indicating a difference between a variational posterior probability distribution and a true posterior probability distribution of the DNN. The method further includes perturbing the training data to generate perturbed training data; and calculating a second term for indicating a quantification of predictive uncertainty on the perturbed training data. The method further includes updating the plurality of sets of weights candidates of the DNN based on augmenting the summation of the first term and the second term.

### FIELD

Aspects of the present invention relate generally to artificial intelligence, and more particularly, to deep neural networks having the ability for adversarial detection.

### BACKGROUND INFORMATION

Deep neural networks (DNNs) generally refer to networks containing more than one hidden layers. The development of DNNs has brought great success in extensive industrial applications, such as image classification, face recognition and object detection etc. However, despite their promising expressiveness, DNNs are highly vulnerable to adversarial examples, which are generated by adding human-imperceptible perturbations upon clean examples to deliberately cause misclassification. The threats from adversarial examples have been witnessed in a wide spectrum of practical systems, raising a requirement for advanced techniques to achieve robust and reliable decision making, especially in safety-critical scenarios.

As one adversarial defense method, adversarial training introduces adversarial examples into training to explicitly tailor the decision boundaries of the DNN model. This adversarial training method causes added training overheads and typically leads to degraded predictive performance on clean examples. On the other hand, adversarial detection methods are usually developed for specific tasks (e.g., image classification) or for specific adversarial attacks, lacking the flexibility to effectively generalize to other tasks or attacks.

Bayesian neural networks (BNNs) may be employed as a way for adversarial detection due to their ability of estimating posterior probability theoretically. However, in practice, implementation of a BNN for adversarial detection would confront difficulties. For example, the training efficiency for a BNN is a problem because the BNN typically involves much larger amounts of parameters than a typical DNN. The accuracy and reliability of the adversarial detection by the BNN is also a challenge for the design of the BNN. And the task-dependent predictive performance of the BNN in addition to the adversarial detection performance is also a challenge.

There exists the need for developing a practical adversarial detection method by addressing at least some of the aforementioned issues, to reach a good balance among at least some of the predictive performance, quality of uncertainty estimates and learning efficiency.

### SUMMARY

The following presents a simplified summary of one or more aspects of the present invention in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An appealing way for adversarial detection is to train a deep neural network to be Bayesian to distinguish adversarial examples from benign ones to bypass their safety threats. As the uncertainty quantification purely acquired from Bayesian principle may be unreliable for perceiving adversarial examples, thus it may improve the performance for adversarial detection by utilizing an adversarial detection-oriented uncertainty correction according to an aspect of the present. To achieve efficient learning with high-quality outcomes, the Bayesian neural network method can be only performed in a few layers, especially the last few layers of the deep neural network model due to their crucial role for determining model behavior, while keeps the other layers deterministic, according to an aspect of the disclosure.

According to an example embodiment of the present invention, a method for training a deep neural network (DNN) which is configured with a plurality of sets of weights candidates is provided. The method comprises: inputting training data selected from a training data set to the DNN; calculating, based on the training data, a first term for indicating a difference between a variational posterior probability distribution and a true posterior probability distribution of the DNN; perturbing the training data to generate perturbed training data; calculating a second term for indicating a quantification of predictive uncertainty on the perturbed training data; and updating the plurality of sets of weights candidates of the DNN based on augmenting the summation of the first term and the second term.

According to a further embodiment of the present invention, the method for training a DNN further comprises: the plurality of sets of weights candidates includes a first subset of weights and a plurality of second subsets of weights candidates, each set of the plurality of sets of weights candidates comprises the first subset of weights and one second subset of the plurality of second subsets of weights candidates.

According to another embodiment of the present invention, a method for using a deep neural network (DNN) trained with the method for training the DNN for adversarial detection is disclosed hereinafter. The method comprises: feeding an input to the DNN; generating one or more task-dependent predictions of the input; estimating a predictive uncertainty of the one or more task-dependent predictions concurrently; and determining whether to accept the one or more task-dependent predictions based on the predictive uncertainty.

According to an embodiment of the present invention, a method for training an image classifier comprising a deep neural network (DNN) which is configured with a plurality of sets of weights candidates is provided. The method comprises: inputting image training data selected from an image training data set to the DNN; calculating, based on the image training data, a first term for indicating a difference between a variational posterior probability distribution and a true posterior probability distribution of the DNN; perturbing the image training data to generate perturbed training data; calculating a second term for indicating a quantification of predictive uncertainty on the perturbed training data; and updating the plurality of sets of weights candidates of the DNN based on augmenting the summation of the first term and the second term.

According to an embodiment of the present invention, a method for training an object detector comprising a deep neural network (DNN) which is configured with a plurality of sets of weights candidates is provided. The method comprises: inputting photo training data selected from an photo training data set to the DNN; calculating, based on the photo training data, a first term for indicating a difference between a variational posterior probability distribution and a true posterior probability distribution of the DNN; perturbing the photo training data to generate perturbed training data; calculating a second term for indicating a quantification of predictive uncertainty on the perturbed training data; and updating the plurality of sets of weights candidates of the DNN based on augmenting the summation of the first term and the second term.

According to an embodiment of the present invention, a method for training a speech recognition system comprising a deep neural network (DNN) which is configured with a plurality of sets of weights candidates is provided. The method comprises: inputting voice training data selected from a voice training data set to the DNN; calculating, based on the voice training data, a first term for indicating a difference between a variational posterior probability distribution and a true posterior probability distribution of the DNN; perturbing the voice training data to generate perturbed training data; calculating a second term for indicating a quantification of predictive uncertainty on the perturbed training data; and updating the plurality of sets of weights candidates of the DNN based on augmenting the summation of the first term and the second term.

The present invention enables a DNN to quickly and cheaply endow the ability to detect various adversarial examples when facing new tasks, such as image classification, face recognition, object detection, speech recognition, etc. Further, all downstream systems that include deep neural networks would be more robustness when facing adversarial attacks, to name a few, autonomous vehicles, industrial product abnormal detection systems, medical diagnosis systems, text-to-speech systems, image recognition system, etc.

### BRIEF DESCRIPTION OF THE DRAWINGS

The disclosed aspects of the present invention will be described in connection with the figures that are provided to illustrate and not to limit the disclosed aspects.

FIG. 1A illustrates an exemplary adversarial attack, in accordance with various aspects of the present invention.

FIG. 1B illustrates exemplary adversarial examples in data manifold, in accordance with various aspects of the present invention.

FIG. 2 illustrates an exemplary deep neural network (DNN) 210 and an exemplary Bayesian neural network (BNN) 220, in accordance with various aspects of the present invention.

FIG. 3 is a flow chart illustrating an exemplary DNN training procedure 300, in accordance with various aspects of the present invention.

FIG. 4 is a block diagram illustrating an exemplary DNN 400 with a trained Bayesian sub-module, in accordance with various aspects of the present invention.

FIG. 5 is a flow chart illustrating an exemplary DNN training procedure 500, in accordance with various aspects of the present invention.

FIG. 6 is a flow chart illustrating an exemplary DNN inference procedure 600, in accordance with various aspects of the present invention.

FIG. 7 illustrates an exemplary computing system 700, in accordance with various aspects of the present invention.

### DETAILED DESCRIPTION OF EXAMPLE EMBODIMENTS

The present invention will now be discussed with reference to several example implementations. It is to be understood that these implementations are discussed only for enabling those skilled in the art to better understand and thus implement the embodiments of the present invention, rather than suggesting any limitations on the scope of the present invention.

Various embodiments will be described in detail with reference to the figures. Wherever possible, the same reference numbers will be used throughout the figures to refer to the same or like parts. References made to particular examples and embodiments are for illustrative purposes, and are not intended to limit the scope of the disclosure.

Deep neural networks (DNNs) have achieved state-of-the-art performance on a wide variety of machine learning tasks and are becoming increasingly popular in domains such as computer vision, speech recognition, natural language processing, and bioinformatics. For example, typical DNNs can include a plurality of layers, such as an input layer, multiple hidden layers and an output layer. Although DNNs are known to be robust to noisy inputs, they are vulnerable to specially crafted adversarial examples, since DNNs are poor at quantifying predictive uncertainty and tend to produce overconfident predictions.

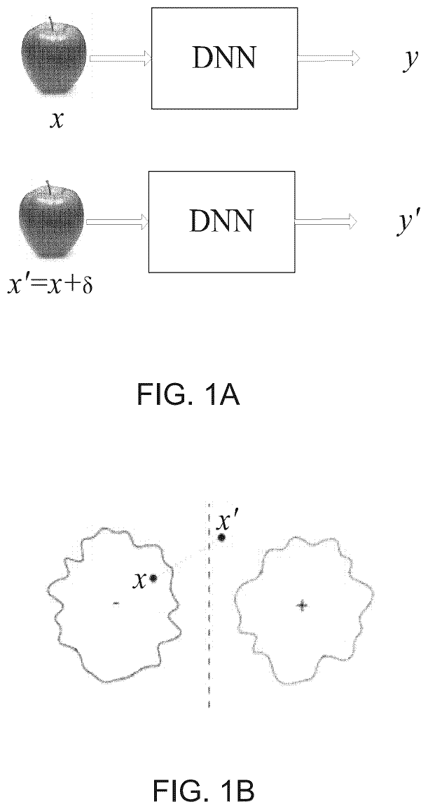

FIG. 1A illustrates an exemplary adversarial attack, in accordance with various aspects of the present invention.

In the example as illustrated in FIG. 1A, normally after receiving an input x, which can either be an image, a clip of audio, a photo, etc. Here, an image of an apple is taken as an example, a DNN may output a label y which indicates “apple” by inferencing based on the input x. A perturbation 5 may be added to the input x to generate a perturbed input x′. For a human, the perturbed input x′ still looks like an apple, however the DNN may incorrectly classify the perturbed input x′ as y′, which for example is a label indicating “pear”. The perturbed input x′ may be referred to as an adversarial example, which is intentionally-perturbed to induce the DNNs to make incorrect predictions with high confidence. In an embodiment, adversarial examples with only small perturbations which are human-imperceptible to the original inputs can induce high-efficacy DNNs to misclassify at a high rate. In another embodiment, adversarial examples can induce DNNs to output a specific target class.

Although the DNN model shown in FIG. 1A is used for a task for image classification, it is appreciated that the DNN may be a neural network model for any specific task. For example, the DNN may be a convolution neural network (CNN) model for performing a machine learning task of image classification. For example, the DNN may be a CNN model for performing a machine learning task of objection detection in images, where the objection detection may be used for tracking an object in exemplary scenarios of automatic driving, surveillance system, etc. For example, the DNN may be a graph neural network (GNN) such as a graph convolution network (GCN) model, which may perform a machine learning task of classifying nodes in a graph, which may for example represents a social network, biological network, citation network, recommendation system, financial system, etc. It is appreciated that the aspects of the disclosure may be applied in but not limited to these exemplary fields or scenarios to improve the security and robustness of these systems by adversarial detection.

FIG. 1B illustrates exemplary adversarial examples in a data manifold, in accordance with various aspects of the present disclosure.

In an embodiment, let [symbol] ={(xᵢ,yᵢ)}ᵢ₌₁ⁿ denote a collection of n training samples with xᵢ∈ [symbol] ^{d} and yᵢ∈Y as the input data and label, respectively. For example, the xᵢ and yᵢ in a training example may be the picture of apple and the label indicating apple as shown in FIG. 1A. A deep neural network (DNN) parameterized by ω∈ [symbol] ^{p} may be frequently trained via maximum a posteriori estimation (MAP):

$${max}_{ω} \frac{1}{n} {\sum }_{i = 1}^{n} log p ( {y}_{i} \vert {x}_{i} ; ω ) + \frac{1}{n} log p ( ω ) \qquad ( 1 )$$

where p(y|x;ω) refers to the predictive distribution of the DNN model. In an embodiment, by setting the prior distribution p(ω) as an isotropic Gaussian, the second term in equation (1) amounts to the L2 (weight decay) regularizer with a tunable coefficient λ in optimization. Generally speaking, in order to find an adversarial example that can induce the DNN to inference incorrectly, the adversarial example corresponding to (xᵢ,yᵢ) against the DNN model is defined as:

$${x}_{i}^{a d v} = {x}_{i} + {arg min}_{{δ}_{i} ∈ S} log p ( {y}_{i} \vert {x}_{i} + {δ}_{i} ; ω ) \qquad ( 2 )$$

where S={δ:∥δ∥≤ε} is the valid perturbation set with ε>0 as the perturbation budget and ∥⋅∥ as some norm (e.g., l_{∞}). In an embodiment, the minimization problem in Eq. (2) is solved based on gradients.

The central goal of adversarial defense is to protect the DNN model from making undesirable decisions for the adversarial examples xᵢ^{adv}. In essence, the problem of distinguishing adversarial examples from benign ones can be viewed as a specialized out-of-distribution (OOD) detection problem, which may be of particular concern in safety-sensitive scenarios. With the DNN model trained on the clean data, it is expected to identify the adversarial examples from a shifted data manifold, as shown in FIG. 1B, though the shift magnitude may be subtle and human-imperceptible.

In the schematic data manifold illustrated in FIG. 1B, the dash line denotes the decision boundary of the DNN model such as the DNN shown in FIG. 1A, two submanifolds that would be classified by the DNN model as “+” and “−” respectively are resulted from training the DNN model with the training data set. As illustrated, by perturbing the input x in the way shown in equation (2), the adversarial example x′ would be incorrectly classified as label “+”. However, it is expected to identify this adversarial example x′ as it is out of distribution of the submanifold corresponding to label “+”.

In this sense, Bayesian neural networks (BNNs) are introduced taking advantage of their principled OOD detection capacity along with the equivalent flexibility for data fitting as DNNs according to aspect of the disclosure.

FIG. 2 illustrates an exemplary deep neural network (DNN) 210 and an exemplary Bayesian neural network (BNN) 220, in accordance with various aspects of the present disclosure. Generally, DNNs are networks with point-estimates as weights, while BNNs are networks with probability distribution as weights, resulting in BNNs are more robust to over-fitting, and can easily learn from small datasets.

For adversarial detection, the epistemic uncertainty which stems from the insufficient exploration of the data space (e.g., the model has never seen adversarial examples during training) is needed. The measure of uncertainty related to the prediction is missing from the current DNNs architectures, while the Bayesian approach offers uncertainty estimates via its parameters in form of probability distributions.

Typically, a BNN is specified by a parameter prior p(ω) and a neural network (NN)-instantiated data likelihood p( [symbol] |ω). The parameter posterior distribution p(ω| [symbol] ) is to be derived instead of a point estimate as in DNN. Since that precisely deriving the posterior is intractable owing to the high non-linearity of neural networks, variational inference is usually used to approximate the true posterior distribution. Generally, in variational BNNs, a variational distribution q(ω|θ) with parameters θ is introduced and the evidence lower bound (ELBO) for learning (scaled by 1/n) is maximized as illustrated in equation (3):

$${max}_{θ} {𝔼}_{q ( ω \vert θ )} [ \frac{1}{n} {\sum }_{i = 1}^{n} log p ( {y}_{i} \vert {x}_{i} ; ω ) ] - \frac{1}{n} {D}_{K L} ( q ( ω \vert θ ) ‖ p ( ω ) ) \qquad ( 3 )$$

where D_{KL} denotes the Kullback-Leibler (KL) divergence between the variational distribution q(ω|θ) and the true Bayesian posterior p(ω) the weights.

The obtained posterior provides for the opportunities to predict robustly. For computational tractability, the posterior predictive may be estimated via the equation (4):

$$p ( y \vert x , 𝒟 ) = {𝔼}_{q ( ω \vert θ )} [ p ( y \vert x ; ω ) ] \approx \frac{1}{T} {\sum }_{t = 1}^{T} p ( y \vert x , {ω}^{( t )} ) \qquad ( 4 )$$

Where ω^{(t)}˜q(ω|θ), t=1, . . . ,T denote the Monte Carlo (MC) samples. In other words, the BNN assembles the predictions yielded by all likely models (i.e., T models corresponding to T sets of weights) to make more reliable and calibrated decisions in contrast with the DNN which only cares about the most possible parameter point.

In an embodiment, the uncertainty metric is the softmax variance given its success for adversarial detection, especially in image classification.

In another embodiment, to make the metric applicable to diverse scenarios, the predictive variance of the hidden feature z corresponding to input x is considered to be the uncertainty metric, by mildly assuming the information flow inside the model as x→z→y. An unbiased variance estimator may be utilized, and the variance of all coordinates of z may be summarized into a scalar as the uncertainty metric via the equation (5):

$$U ( x ) = \frac{1}{T - 1} [ {\sum }_{t = 1}^{T} {‖ {z}^{( t )} ‖}_{2}^{2} - T ( {‖ \frac{1}{T} {\sum }_{t = 1}^{T} {z}^{( t )} ‖}_{2}^{2} ) ] \qquad ( 5 )$$

where z^{(t)} denotes the features of x under parameter sample ω^{(t)}˜q(ω|θ), t=1, . . . ,T, with ∥⋅∥₂² as l₂ norm. In an embodiment, the task dependent prediction of the model and the corresponding uncertainty metric can be made simultaneously via Eq. (4) and (5) during inference. In other embodiment, the uncertainty metric can be quantified after the prediction is made.

Despite the attractiveness of BNNs for quantifying predictive uncertainty, what concerned is BNNs' training efficiency, predictive performance, quality of uncertainty estimates and inference speed. The present disclosure provides for a method for training DNNs to endow the ability to detect adversarial examples while overcoming the issues of BNNs to reach a good balance among the aforementioned concerns.

The core of variational BNNs lies the configuration of the variational distribution. Such variational distribution can include but not limited to mean-field Gaussian, matrix-variate Gaussian, low-rank Gaussian, MC Dropout, multiplicative normalizing flows and even implicit distributions, etc. However, the more approachable variationals tend to concentrate on a single mode in the function space, rendering the yielded uncertainty estimates unreliable.

The present disclosure utilizes a variational distribution which can be explained in the variational Bayesian perspective, it builds a set of weights candidates, θ={ω^{(c)}}_{c=1}^{c}, which accounts for diverse function modes and assigns uniform probabilities over them. Namely,

$$q ( ω \vert θ ) = \frac{1}{C} {\sum }_{c = 1}^{C} δ ( ω - {ω}^{( c )} ) .$$

In an embodiment, δ refers to the Dirac delta function; in another embodiment, δ refers to the weight decay Dirac delta function; in yet another embodiment, δ refers to a plurality samples from Gaussian. Although the Dirac delta function is taken as an example hereinafter, it will not be limiting, δ would denote to a variety of discrete probability. Thus, inferring such a variational posterior amounts to training C separate DNNs.

In an embodiment, all the layers of a DNN may be trained to be Bayesian layers to acquire adequate capacity.

In another embodiment, only a few layers of the feature extraction module of a DNN may be trained to be Bayesian layers to save computational cost. For example, the few layers of the DNN may include only one layer. As another example, the few layers of the DNN may include only the last feature extraction layer of the DNN, excluding the task-dependent output head. As yet another example, the few layers of the DNN include a plurality of successive layers of the feature extraction module of the DNN, the plurality of successive layers are trained to be a Bayesian sub-module. In this case, the immediate output of the Bayesian sub-module can be taken as the hidden feature z in Eq. (5). In yet another aspect, a DNN can be trained to have a plurality of Bayesian sub-modules.

In an embodiment, only a few layers of the feature extraction module of the DNN are to be trained to be Bayesian layers, the parameter weights ω of the DNN is divided into ω_{b} and ω_{-b}, which denote the weights of parameters of the tiny Bayesian sub-module and the weights of the other parameters of the DNN model respectively, then the Few-Layer Deep Ensemble (FADE) variational is obtained as illustrated in equation (6):

$$q ( ω \vert θ ) = \frac{1}{C} {\sum }_{c = 1}^{C} δ ( {ω}_{b} - {ω}_{b}^{( c )} ) δ ( {ω}_{- b} - {ω}_{- b}^{( 0 )} ) \qquad ( 6 )$$

where θ={ω_{-b}⁽⁰⁾, ω_{b}⁽¹⁾, . . . , ω_{b}^{(C)}}, and δ refers to the Dirac delta function. Intuitively, FADE will ease and accelerate the learning, permitting scaling Bayesian inference up to deep architectures trivially.

Given the disclosed FADE variational, the present disclosure provides an effective and user-friendly implementation for learning. Equally assuming an isotropic Gaussian prior as the MAP estimation for DNN, the second term of the ELBO in Eq. (3) boils down to a weight decay regularizer with coefficients λ on ω_{-b}⁽⁰⁾ and

$$\frac{λ}{C}$$

on ω_{b}^{(c)}, c=c=1, . . . , C, can be easily implemented inside the optimizer. Then, it only needs to explicitly deal with the first term in the ELBO. Analytically estimating the expectation in the first term is feasible but may hinder different weights candidates from exploring diverse function modes (as they may undergo similar optimization trajectories). Thus, in an embodiment, it is proposed to maximize a stochastic estimation of the first term in ELBO on top of stochastic gradient ascent via the equation (7):

$${max}_{θ} L = \frac{1}{\vert B \vert} {\sum }_{( {x}_{i} , {y}_{i} ) ∈ B} log p ( {y}_{i} \vert {x}_{i} ; {ω}_{b}^{( c )} , {ω}_{- b}^{( 0 )} ) \qquad ( 7 )$$

where B is a stochastic mini-batch selected from a training data set, and c is drawn from unif {1, C}, i.e., the uniform distribution over {1, . . . , C}. In another embodiment, the first term in the ELBO may be maximized by gradient ascent or other common approach.

However, ∇_{ω}_{_{−b}}_{⁽⁰⁾}L exhibits high variance across iterations due to its correlation with the varying choice of c, which is harmful for the convergence. To disentangle such correlation, in an embodiment, the batch-wise parameter sample ω_{b}^{(c)} may be replaced with instance-wise ones ω_{b}^{(c}^{ᵢ}⁾, cᵢ^{i.i.d}˜unif{1, C}, i=1, . . . |B|, for example, cᵢ is selected with an independent identically distribution over {1, . . . , C}, which ensures ω_{-b}⁽⁰⁾ to comprehensively consider the variable behavior of the Bayesian sub-module at per iteration. In this embodiment, it is proposed to maximize a stochastic estimation of the first term in ELBO for training via the equation (8):

$${max}_{θ} {L}^{*} = \frac{1}{\vert B \vert} {\sum }_{( {x}_{i} , {y}_{i} ) ∈ B} log p ( {y}_{i} \vert {x}_{i} ; {ω}_{b}^{( {c}_{i} )} , {ω}_{- b}^{( 0 )} ) \qquad ( 8 )$$

Under such a learning criterion, each Bayesian weights candidate ω_{b}^{(c)} accounts for a stochastically assigned, separate subset of B.

Such stochasticity will be injected into the gradient ascent dynamics and serves as an implicit regularization, leading the Bayesian weights candidates {ω_{b}^{(c)}}_{c=1}^{C} to investigate diverse weight sub-spaces and ideally diverse function modes.

As a special category of OOD data, adversarial examples hold several special characteristics, e.g., the close resemblance to benign data and the strong offensive to the behavior of black-box deep models, which may easily destroy the uncertainty based adversarial detection. A common strategy to address this issue is to incorporate adversarial examples crafted by specific attacks into detector training, which, yet, is costly and may limit the learned models from generalizing to unseen attacks.

Instead, an adversarial example free uncertainty correction strategy by considering a superset of the adversarial examples is disclosed in the present disclosure. Uniformly perturbed training instances (which encompass all kinds of adversarial examples) are fed into the DNN having one or more Bayesian sub-modules and relatively high predictive uncertainty is demanded on them, to train the DNN with the ability of detecting various kinds of adversarial examples.

Formally, with εₜᵣₐᵢₙ notating the training perturbation budget, a mini-batch of data can be contaminated via the equation (9):

$${\tilde{x}}_{i} = {x}_{i} + {δ}_{i} , {δ}_{i} {∼}^{i . i . d} {μ ( - {ε}_{train} , {ε}_{train} )}^{d} , i = 1 , … , \vert B \vert \qquad ( 9 )$$

Then the uncertainty measure U is calculated with T=2 MC samples, and the outcome is regularized via solving the following margin loss illustrated in the equation (10):

$${max}_{θ} R = \frac{1}{\vert B \vert} {\sum }_{( {x}_{i} , {y}_{i} ) ∈ B} min ( {‖ {{\tilde{z}}_{i}}^{( {c}_{i , 1} )} - {{\tilde{z}}_{i}}^{( {c}_{i , 2} )} ‖}_{2}^{2} , γ ) \qquad ( 10 )$$

where [symbol] ^{(c}^{_{i,j}}⁾ refers to the features of [symbol] given parameter sample ω^{(c}^{_{i,j}}⁾={ω_{b}^{(c}^{_{i,j}}⁾, ω_{-b}⁰} with

$${c}_{i , j} {∼}^{i . i . d} unif \{ 1 , C \} , and {c}_{i , 1} \neq {c}_{i , 2} , i = 1 , … , \vert B \vert , j = 1 , 2.$$

γ is a tunable threshold.

Training the DNN with Eq. (10) is to demand predictive uncertainty at least larger than γ on the perturbed examples, thereby an instance with a predictive uncertainty larger than γ will be considered as an adversarial example and rejected during inference.

n some embodiments, as the main part (i.e., ω_{-b}⁰) of the model remains deterministic, it enables to perform only once forward propagation to reach the entry of the Bayesian sub-module (i.e., {ω_{b}^{(c)}}_{c=1}^{C}). Therefore the calculation speed either in the inference stage after learning may be improved thanks to the adoption of the FADE variational. In the Bayesian sub-module, all the C weights candidates are taken into account for prediction to thoroughly exploit their heterogeneous predictive behavior, i.e., T=C. Sequentially calculating the outcomes under each weights candidate ω_{b}^{(c)} is viable in an embodiment. In another embodiment, further inference speedup can be achieved through parallel computing for all the weights candidates.

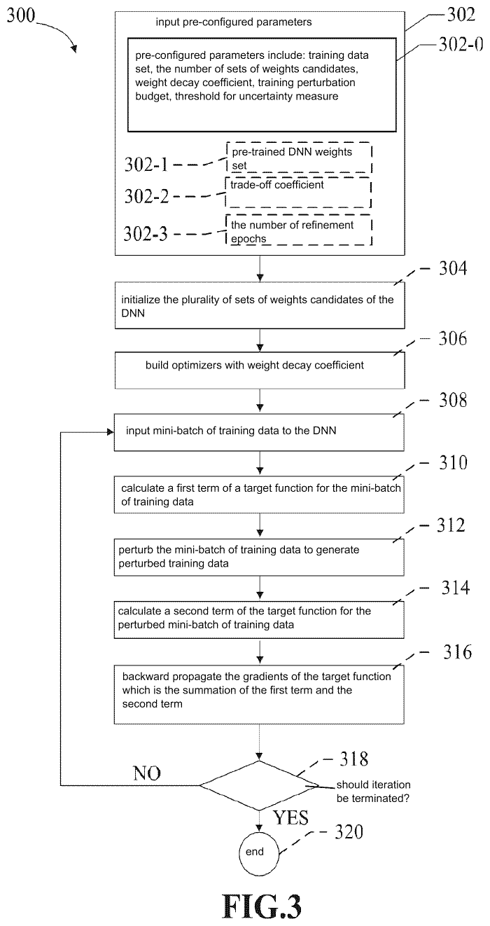

FIG. 3 is a flow chart illustrating an exemplary DNN training procedure 300, in accordance with various aspects of the present disclosure, the DNN may be comprised in an image classifier, a speech recognition system, an object detection system, etc. As described below, some or all illustrated features may be omitted in a particular implementation within the scope of the present disclosure, and some illustrated features may not be required for implementation of all embodiments. In some examples, the procedure 300 may be carried out by any suitable apparatus or means for carrying out the functions or algorithm described below. It should be understood that operations shown with dashed lines in FIG. 3 indicate optional operations.

At 302, the training procedure is begun with inputting some pre-configured parameters to the DNN, which is configured with a plurality of sets of weights candidates. The pre-configured parameters may include but not limit to: a training data set [symbol] , the number of the sets of weights candidates C, weight decay coefficient λ, training perturbation budget εₜᵣₐᵢₙ, a threshold γ for uncertainty measure, as shown in the solid-lined block 302-0, wherein the training data set [symbol] may either include images, audios, photos, etc., based on which kind of system the DNN is comprised in.

In an embodiment, the pre-configured parameters may further include a pre-trained DNN weights set ω⁺, as shown in the dashed-lined block 302-1. Given the alignment between the posterior parameters θ and their DNN counterparts, to perform a cost-effective Bayesian refinement upon a pre-trained DNN model is preferred, which may render the workflow more appropriate for large-scale learning. It is appreciated that from-scratch BNN training without using the pre-trained DNN weights set is also feasible.

In another embodiment, the pre-configured parameters may further include a trade-off coefficient α for making up the objective function for learning, as shown in the dashed-lined block 302-2. As discussed above, there leaves two terms for tuning, a first term for indicating a difference between a variational posterior probability distribution and a true posterior probability distribution of the DNN, and a second term for indicating a quantification of predictive uncertainty on the perturbed training data. In an aspect, the objective function for learning is the summation of the first term and the second term. In another aspect, the objective function for learning is the summation of the first term and the second term, and the second term is added to the first term by a tradeoff coefficient.

In yet another embodiment, the pre-configured parameters may further include the number of refinement epochs E for indicating the number of times to traverse the training data set [symbol] , as shown in the dashed-lined block 302-3.

At 304, the training procedure proceeds to initialize the plurality of sets of weights candidates of the DNN.

In an embodiment, the plurality of sets of weights candidates θ={ω⁽¹⁾, . . . , ω^{(C)}} is initialized stochastically, for example, randomly generated values are used to initialize the plurality of sets of weights candidates.

In another embodiment, with only a few layers of the DNN to be trained to be Bayesian layers, the plurality of sets of weights candidates θ={ω_{-b}⁽⁰⁾, ω_{b}⁽¹⁾, . . . , ω_{b}^{(C)}} comprises a first subset of weights θ₁={ω_{-b}⁽⁰⁾} and a plurality of second subsets of weights candidates θ₂={ω_{b}⁽¹⁾, . . . , ω_{b}^{(C)}}, wherein each set of the plurality of sets of weights candidates comprises the first subset of weights and one second subset of the plurality of second subsets of weights candidates, ω(c)={ω_{-b}⁽⁰⁾, ω_{b}^{(c)}}, where c=1, . . . , C. In this case, the plurality of sets of weights candidates θ is initialized based on the pre-trained DNN weights set ω⁺, denoted as ω⁺={ω_{b}⁺, ω_{-b}⁺}. ω_{-b}⁽⁰⁾ may be initialized as ω_{-b}⁺, and ω_{b}^{(c)} may be initialized as ω_{b}⁺ or c=1, . . . , C.

At 306, the training procedure proceeds to build optimizers with weight decay coefficient λ. As discussed above, equally assuming an isotropic Gaussian prior as the MAP estimation for DNN, the second term of the ELBO in Eq. (3) boils down to a weight decay regularizer with a coefficient λ.

In an embodiment, an optimizer opt_{b} with weight decay

$$\frac{λ}{C}$$

may be built for θ={ω⁽¹⁾, . . . , ω^{(c)}}_{c=1}^{C}, when all the layers of the DNN to be trained to be Bayesian layers.

In another embodiment, it may build an optimizer opt_{-b} with weight decay λ for θ₁={ω_{-b}⁽⁰⁾}, and build an optimizer opt_{b} with weight decay

$$\frac{λ}{C}$$

for θ₂={ω_{b}⁽¹⁾, . . . , ω_{b}^{(c)}}_{c=1}^{C} respectively, when only a few layers of the DNN to be trained to be Bayesian layers.

Continuing from this, the training procedure is to fine-tune the variational parameters to augment a target function for training by virtue of weight decay regularizers with suitable coefficients to realize adversarial detection-oriented posterior inference.

At 308, the training procedure proceeds to input a mini-batch of training data B={(xᵢ,yᵢ)}ᵢ₌₁^{|B|} to the DNN. In an embodiment, the mini-batch of training data B is stochastically selected from the training data set [symbol] .

At 310, the training procedure proceeds to calculate a first term of a target function for the mini-batch of training data B, wherein the first term indicates a difference between a variational posterior probability distribution and a true posterior probability distribution of the DNN.

In an embodiment, the first term is the evidence lower bound (ELBO) of the variational posterior probability distribution in Eq. (3).

In another embodiment, the first term of the target function is the log-likelihood function L calculated based on mini-batch-wise weight sample ω_{b}^{(c)} corresponding to the parameters of the Bayesian layers, as discussed above in Eq. (7), wherein the mini-batch-wise weight sample ω_{b}^{(c)} is selected stochastically for the mini-batch of training data.

In yet another embodiment, the first term of the target function is the log-likelihood function L* calculated based on instance-wise weight samples ω_{b}^{(c}^{ᵢ}⁾, as discussed above in Eq. (8), wherein the instance-wise weight sample ω_{b}^{(c}^{ᵢ}⁾ is stochastically selected for each training data sample in the mini-batch of training data.

At 312, the training procedure proceeds to perturb the mini-batch of training data to generate perturbed training data, as discussed above in Eq. (9).

In an embodiment, the mini-batch of training data can be perturbed uniformly to encompass all kinds of adversarial examples.

In another embodiment, the mini-batch of training data can be perturbed to target on a certain kind of adversarial example.

At 314, the training procedure proceeds to calculate a second term of the target function for the perturbed mini-batch of training data, wherein the second term indicates a quantification of predictive uncertainty on the perturbed training data.

In an embodiment, the second term of the target function may be the predictive variance of the hidden feature corresponding to training data, as U(x) discussed above in Eq. (5).

In another embodiment, the second term of the target function may be a regularization term of the predictive uncertainty U(x) on the perturbed training data compared with the predefined threshold γ, as R discussed above in Eq. (10).

At 316, the training procedure proceeds to backward propagate the gradients of the target function which is the summation of the first term and the second term, and update the plurality of sets of weights candidates of the DNN based on augmenting the target function. For example, the target function is augmented by performing stochastic gradient ascent.

In an embodiment, the target function is the summation of the first term and the second term. In another embodiment, the second term is added to the first term by a tradeoff coefficient to form the target function.

In an embodiment, the plurality of sets of weights candidates of the DNN may be updated by the optimizer with opt_{b} when all the layers of the DNN are to be trained to be Bayesian layers.

In another embodiment, the first subset of weights and the plurality of second subsets of weights candidates may be updated by the optimizer with opt_{b} and opt_{-b} respectively, when only a few layers of the DNN to be trained to be Bayesian layers.

At 318, the training procedure proceeds to determine whether the iteration should be terminated.

In an embodiment, the updating is performed until the summation of the value of the target function is maximized.

In another embodiment, the updating is performed until the value of the target function satisfies a threshold.

In yet another embodiment, the updating is performed until the value of the target function reaches a convergence.

In still another embodiment, the updating is performed over the training data set for a predefined number of times indicated by the refinement epochs E.

If the iteration is not terminated as determined at 318, the procedure loops back to 308, otherwise, the procedure ends at 320.

An exemplary Algorithmic procedure is presented by way of pseudo code below in Table 1.

TABLE 1
Algorithm 1

| | |
|---|---|
| Input: | pre-trained DNN parameters ω⁺, |
| | training set D, |
| | number of candidates C, |
| | weight decay coefficient λ, |
| | training perturbation budget εₜᵣₐᵢₙ, |
| | threshold γ, |
| | trade-off coefficient α, |
| | refinement epochs E |

```
Initialize {ω_{b}^{(c)}}_{c=1}^{C} and {ω_{-b}⁽⁰⁾} based on ω⁺
Build optimizers opt_{b} and opt_{-b} with
weight decay λ/C and λ
for {ω_{b}^{(c)}}_{c=1}^{C} and {ω_{-b}⁽⁰⁾} respectively
for epoch = 1,...,E do
  for mini-batch B = {(xᵢ, yᵢ)}ᵢ₌₁^{|B|} in D do
    estimate the log-likelihood L*via Eq. (8)
    uniformly perturb the clean data via Eq. (9)
    estimate the measure of uncertainty R via Eq. (10)
    backward the gradients of L* + αR
    perform 1-step gradient ascent with opt_{b} and opt_{-b}
```

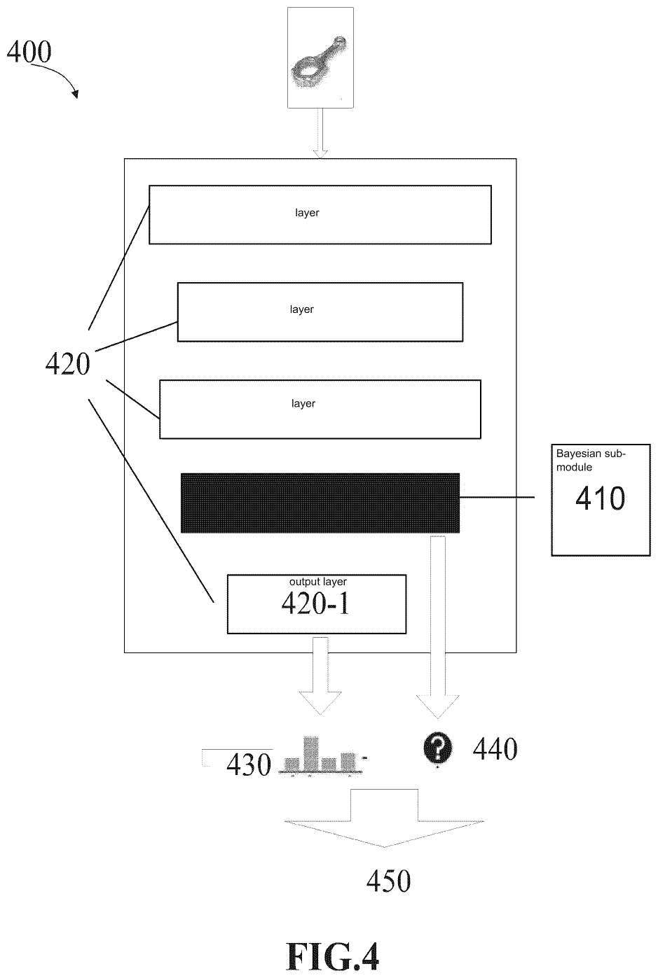

FIG. 4 is a block diagram illustrating an exemplary DNN 400 with a Bayesian sub-module, in accordance with various aspects of the present disclosure.

As shown in FIG. 4, there is a Bayesian sub-module 410 in the DNN 400. The Bayesian sub-module 410 includes at least one layer of the DNN, while the other layers 420 of the DNN 400 remain deterministic.

In an embodiment, the output layer 420-1 is the task dependent output head that output task dependent predictions 430 based on the features from previous layer such as the at least one layer 410. In this embodiment, the at least one layer 410 includes the last layer excluding the task dependent output head.

to be a Bayesian sub-module, trained to have several Bayesian (excluding the task-dependent output head), etc.

The Bayesian sub-module 410 may calculate the uncertainty metric based on the features obtained in the at least one layer of the sub-module 410, for example, based on the equation (5) during inference. It may determine whether the current input x is a benign one or an adversarial one based on the uncertainty metric at 440. Then the task dependent predictions may be accepted or rejected at 450 based on the determination obtained at 440.

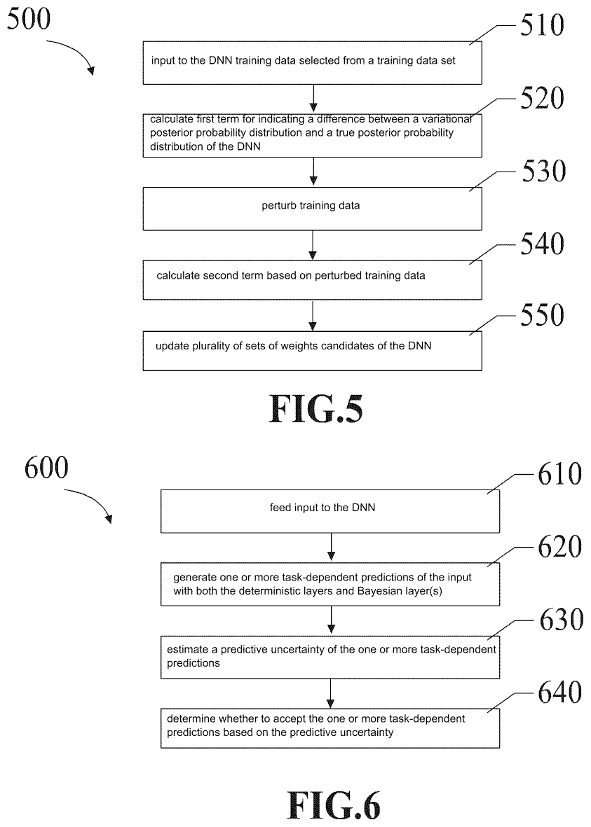

FIG. 5 is a flow chart illustrating an exemplary method for training a deep neural network (DNN) capable of adversarial detection, in accordance with various aspects of the present disclosure.

At 510, training data selected from a training data set is input to the DNN, wherein the DNN is configured with a plurality of sets of weights candidates, wherein the training data set may either include images, audios, photos, etc., based on which kind of system the DNN is comprised in.

At 520, a first term for indicating a difference between a variational posterior probability distribution and a true posterior probability distribution of the DNN is calculated based on the training data.

At 530, the training data is perturbed to generate perturbed training data.

At 540, a second term for indicating a quantification of predictive uncertainty on the perturbed training data is calculated based on the perturbed training data.

At 550, the plurality of sets of weights candidates of the DNN are updated based on augmenting the summation of the first term and the second term.

In an embodiment, the plurality of sets of weights candidates includes a first subset of weights and a plurality of second subsets of weights candidates, each set of the plurality of sets of weights candidates comprises the first subset of weights and one second subset of the plurality of second subsets of weights candidates.

In an embodiment, the first subset of weights is updated with the training data set.

In an embodiment, each second subset of the plurality of second subsets of weights is updated with training data stochastically selected from the training data set.

In an embodiment, each second subset of the plurality of second subset of weights candidates corresponds to at least one layer of the DNN.

In an embodiment, the at least one layer of the DNN comprises the last layer of the DNN.

In an embodiment, the at least one layer of the DNN comprises a plurality of successive layers of the DNN.

In an embodiment, the DNN is pre-trained, and wherein the first subset of weights and a plurality of second subsets of weights candidates are initialized with the pre-trained weights of the DNN.

n an embodiment, the summation of the first term and the second term is augmented by performing stochastic gradient ascent.

In an embodiment, the updating at 550 may be performed by updating the first subset of weights by a first optimizer with a first weight decay coefficient and updating the plurality of second subsets of weights candidates with a second optimizer with a second weight decay coefficient.

In an embodiment, the training data are perturbed uniformly, and the perturbation is within a training perturbation budget.

In an embodiment, the first term is the evidence lower bound (ELBO) of the variational posterior probability distribution.

In an embodiment, the first term is the log-likelihood function on the training data, wherein each instance of the training data corresponds to one stochastically assigned set of weights candidate of the plurality of sets of weights candidates.

In an embodiment, the predictive uncertainty on an instance is calculated as a scalar indicating variance of hidden features of the instance in at least one layer of the DNN corresponding to the second subsets of weights candidates.

n an embodiment, the second term is a regularization term of the predictive uncertainty on the perturbed training data compared with a tunable threshold.

In an embodiment, the second term is added to the first term by a tradeoff coefficient.

FIG. 6 is a flow chart illustrating an exemplary DNN inference procedure 500, in accordance with various aspects of the present disclosure.

At 610, the inference procedure is begun with feeding an input to the DNN, the input includes but not limited to images, audios, signatures, medical imaging etc.

At 620, the inference procedure proceeds to generate one or more task-dependent predictions of the input with both the deterministic layers and Bayesian layer(s), the task includes but not limited to image classification, node classification, face recognition, object detection, speech recognition, etc.

At 630, the inference procedure proceeds to estimate a predictive uncertainty of the one or more task-dependent predictions with the Bayesian layer(s). The operation of 604 and 606 may be performed sequentially or concurrently.

At 640, the inference procedure proceeds to determine whether to accept the one or more task-dependent predictions based on the predictive uncertainty. In an embodiment, the determination further comprises compare the predictive uncertainty of the one or more task-dependent predictions to a threshold, which may be the threshold γ used during training, and determine to reject the one or more task-dependent predictions if their predictive uncertainty is beyond the threshold, indicating that the input is highly possible to be an adversarial example rather than a benign one.

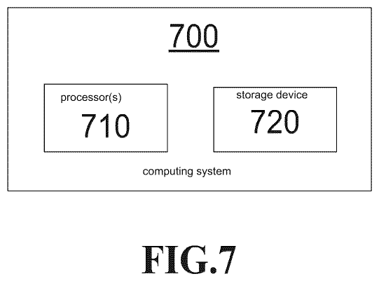

FIG. 7 illustrates an exemplary computing system 700 according to an embodiment. The computing system 700 may comprise at least one processor 710. The computing system 700 may further comprise at least one storage device 720. In an aspect, the storage device 720 may store computer-executable instructions that, when executed, cause the processor 710 to input training data selected from training data set to a DNN which is configured with a plurality of sets of weights candidates; calculate, based on the training data, a first term for indicating a difference between a variational posterior probability distribution and a true posterior probability distribution of the DNN; perturb the training data to generate perturbed training data; calculate a second term for indicating a quantification of predictive uncertainty on the perturbed training data; and update the plurality of sets of weights candidates of the DNN based on augmenting the summation of the first term and the second term.

In a further aspect, the storage device 720 may store computer-executable instructions that, when executed, cause the processor 710 to feed an input to the DNN trained with the method in the present disclosure; generate one or more task-dependent predictions of the input; estimate a predictive uncertainty of the one or more task-dependent predictions concurrently; and determine whether to accept the one or more task-dependent predictions based on the predictive uncertainty.

It should be appreciated that the storage device 720 may store computer-executable instructions that, when executed, cause the processor 710 to perform any operations according to the embodiments of the present disclosure as described in connection with FIGS. 1-6.

The embodiments of the present disclosure may be embodied in a computer-readable medium such as non-transitory computer-readable medium. The non-transitory computer-readable medium may comprise instructions that, when executed, cause one or more processors to perform any operations according to the embodiments of the present disclosure as described in connection with FIGS. 1-6.

The embodiments of the present disclosure may be embodied in a computer program product comprising computer-executable instructions that, when executed, cause one or more processors to perform any operations according to the embodiments of the present disclosure as described in connection with FIGS. 1-6.

It should be appreciated that all the operations in the methods described above are merely exemplary, and the present disclosure is not limited to any operations in the methods or sequence orders of these operations, and should cover all other equivalents under the same or similar concepts.

It should also be appreciated that all the modules in the apparatuses described above may be implemented in various approaches. These modules may be implemented as hardware, software, or a combination thereof. Moreover, any of these modules may be further functionally divided into sub-modules or combined together.

The above description is provided to enable any person skilled in the art to practice the various aspects described herein. Various modifications to these aspects will be readily apparent to those skilled in the art, and the generic principles defined herein may be applied to other aspects. Thus, the present invention is not intended to be limited to the aspects shown herein. All structural and functional equivalents to the elements of the various aspects described throughout the present disclosure that are known or later come to be known to those of ordinary skill in the art are expressly incorporated herein by reference and are intended to be encompassed by the present invention.

1-20. (canceled)

21. A method for training a deep neural network (DNN) capable of adversarial detection, wherein the DNN is configured with a plurality of sets of weights candidates, the method comprising the following steps:
inputting training data selected from a training data set to the DNN;
calculating, based on the training data, a first term for indicating a difference between a variational posterior probability distribution and a true posterior probability distribution of the DNN;
perturbing the training data to generate perturbed training data;
calculating a second term for indicating a quantification of predictive uncertainty on the perturbed training data; and
updating the plurality of sets of weights candidates of the DNN based on augmenting a summation of the first term and the second term.

22. The method of claim 21, wherein the plurality of sets of weights candidates includes a first subset of weights and a plurality of second subsets of weights candidates, each set of the plurality of sets of weights candidates includes the first subset of weights and one second subset of the plurality of second subsets of weights candidates.

23. The method of claim 22, wherein the first subset of weights is updated with the training data set.

24. The method of claim 22, wherein each second subset of the plurality of second subsets of weights is updated with training data stochastically selected from the training data set.

25. The method of claim 22, wherein each second subset of the plurality of second subset of weights candidates corresponds to at least one layer of the DNN.

26. The method of claim 25, wherein the at least one layer of the DNN includes a last layer of the DNN.

27. The method of claim 25, wherein the at least one layer of the DNN includes a plurality of successive layers of the DNN.

28. The method of claim 22, wherein the DNN is pre-trained, and wherein the first subset of weights and the plurality of second subsets of weights candidates are initialized with the pre-trained weights of the DNN.

29. The method of claim 21, wherein the summation of the first term and the second term is augmented by performing stochastic gradient ascent.

30. The method of claim 29, wherein the updating of the plurality of sets of weights candidates of the DNN based on augmenting the summation of the first term and the second term, further includes:
updating the first subset of weights by a first optimizer with a first weight decay coefficient; and
updating the plurality of second subsets of weights candidates with a second optimizer with a second weight decay coefficient.

31. The method of claim 21, wherein the training data are perturbed uniformly, and the perturbation is within a training perturbation budget.

32. The method of claim 21, wherein the first term is an evidence lower bound (ELBO) of the variational posterior probability distribution.

33. The method of claim 21, wherein the first term is a log-likelihood function on the training data, wherein each instance of the training data corresponds to one stochastically assigned set of weights candidate of the plurality of sets of weights candidates.

34. The method of claim 22, wherein the predictive uncertainty on an instance is calculated as a scalar indicating variance of hidden features of the instance in at least one layer of the DNN corresponding to the second subsets of weights candidates.

35. The method of claim 21, wherein the second term is a regularization term of the predictive uncertainty on the perturbed training data compared with a tunable threshold.

36. The method of claim 21, wherein the second term is added to the first term by a tradeoff coefficient.

37. A method for using a deep neural network trained for adversarial detection, the comprising:
feeding an input to the DNN;
generating one or more task-dependent predictions of the input;
estimating a predictive uncertainty of the one or more task-dependent predictions concurrently; and
determining whether to accept the one or more task-dependent predictions based on the predictive uncertainty;
wherein the DNN is configured with a plurality of sets of weights candidates, and the DNN is trained by:
inputting training data selected from a training data set to the DNN;
calculating, based on the training data, a first term for indicating a difference between a variational posterior probability distribution and a true posterior probability distribution of the DNN;
perturbing the training data to generate perturbed training data;
calculating a second term for indicating a quantification of predictive uncertainty on the perturbed training data; and
updating the plurality of sets of weights candidates of the DNN based on augmenting a summation of the first term and the second term.

38. A computer system, comprising:
one or more processors; and
one or more non-transitory storage devices storing computer-executable instructions for training a deep neural network (DNN) capable of adversarial detection, wherein the DNN is configured with a plurality of sets of weights candidates, the instructions, when executed by the one or more processors, causing the one or more processors to perform the following steps:
inputting training data selected from a training data set to the DNN;
calculating, based on the training data, a first term for indicating a difference between a variational posterior probability distribution and a true posterior probability distribution of the DNN;
perturbing the training data to generate perturbed training data;
calculating a second term for indicating a quantification of predictive uncertainty on the perturbed training data; and
updating the plurality of sets of weights candidates of the DNN based on augmenting a summation of the first term and the second term.

39. One or more non-transitory computer readable storage media on which are stored computer-executable instructions for training a deep neural network (DNN) capable of adversarial detection, wherein the DNN is configured with a plurality of sets of weights candidates, the instructions, when executed by one or more processors, causing the one or more processors to perform the following steps:
inputting training data selected from a training data set to the DNN;
calculating, based on the training data, a first term for indicating a difference between a variational posterior probability distribution and a true posterior probability distribution of the DNN;
perturbing the training data to generate perturbed training data;
calculating a second term for indicating a quantification of predictive uncertainty on the perturbed training data; and
updating the plurality of sets of weights candidates of the DNN based on augmenting a summation of the first term and the second term.
